(19) United States
(12) Patent Application Publication
(10) Pub. No.: US 2024/0166176 A1
(43) Pub. Date: May 23, 2024

(54) EMERGENCY EVACUATION DEVICE, MOBILE OBJECT CONTROL SYSTEM, AND EMERGENCY EVACUATION METHOD

(71) Applicant: Mitsubishi Electric Corporation, Tokyo (JP)

(72) Inventors: Toru HIGUCHI, Tokyo (JP); Hiroshi YAMADA, Tokyo (JP); Kohei MORI, Tokyo (JP); Keisuke MORITA, Tokyo (JP)

(73) Assignee: Mitsubishi Electric Corporation, Tokyo (JP)

(21) Appl. No.: 18/378,697

(22) Filed: Oct. 11, 2023

(30) Foreign Application Priority Data
Nov. 21, 2022 (JP) 2022-185524

(51) Int. Cl. B60T 7/22; B60T 7/14

(52) U.S. Cl. CPC B60T 7/22; B60T 7/14; B60T 2210/10; B60T 2250/04

(57) ABSTRACT

This emergency evacuation device includes: an emergency stop requesting unit which detects abnormality from obstacle information acquired from an obstacle information acquisition unit and a roadside information acquisition unit and an occupant physiological state acquired from an occupant state information acquisition unit, and outputs an emergency stop request; a movement permission determination unit which determines movement permission for a mobile object, using the emergency stop request; a movement permission cancellation unit which determines whether or not to cancel movement permission for the mobile object, using a control state of the mobile object acquired from a mobile object state information acquisition unit; and a mobile object control unit which controls movement of the mobile object, using information about movement permission and cancellation of the movement permission. When movement is permitted and the movement permission is not cancelled, the mobile object is allowed to be moved within a certain limited range.

### BACKGROUND OF THE INVENTION

### 1. Field of the Invention

The present disclosure relates to an emergency evacuation device, a mobile object control system, and an emergency evacuation method.

### 2. Description of the Background Art

In recent years, automated driving technology for automobiles have been increasingly developed, and not only driving assistance for a user but also technology for performing automated driving without user's operation is attracting attention. In performing automated driving, in a case where traveling cannot be performed safely as in a case where some of sensors for detecting the surrounding environment around the own vehicle fail, it is required to stop the vehicle in a situation with a low accident risk without obstructing another traffic participant.

For example, in Patent Document 1, when abnormality of an outside environment recognition device for recognizing the surrounding environment around the own vehicle is detected, processing for stopping the vehicle is executed.
Patent Document 1: Japanese Laid-Open Patent Publication No. 2022-24741

In Patent Document 1, in a case where abnormality has occurred in an outside environment recognition system for recognizing the own vehicle surrounding environment, a trajectory for the own vehicle to pass until stopping is generated on the basis of minimum risk maneuver (MRM), but there is inevitably a possibility that the vehicle stops in an area where roads intersect each other in an intersection or the like. Stopping the vehicle in an intersection might obstruct advancement of another traffic participant or cause collision between another traffic participant and the own vehicle. This is because the intersection is an area where roads intersect each other and where the own vehicle greatly influences another traffic participant. Also, in a case where the own vehicle stops at a road shoulder outside an intersection, the own vehicle might obstruct passage of another traffic participant that is to pass on a road connected to the road shoulder or through an entrance/exit of a parking lot, for example. These are problems in considering improvement in automated driving.

### SUMMARY OF THE INVENTION

The present disclosure has been made to solve the above problems, and an object of the present disclosure is to provide an emergency evacuation device, a mobile object control system, and an emergency evacuation method for ensuring safety of an own vehicle without obstructing advancement of another traffic participant when abnormality has occurred in a detector (sensor) for recognizing the surrounding environment around the own vehicle.

An emergency evacuation device according to the present disclosure is an emergency evacuation device which receives obstacle information around a mobile object acquired by an obstacle information acquisition unit, obstacle information around a roadside acquired by a roadside information acquisition unit, physiological state information of an occupant of the mobile object acquired by an occupant state information acquisition unit, and mobile object state information which is a control state of the mobile object acquired by a mobile object state information acquisition unit, the emergency evacuation device including: an emergency stop requesting unit which outputs an emergency stop request when having detected abnormality for at least one of the obstacle information around the mobile object acquired by the obstacle information acquisition unit, the obstacle information around the roadside acquired by the roadside information acquisition unit, and the physiological state information of the occupant; a movement permission determination unit which determines whether or not to permit movement of the mobile object, on the basis of the emergency stop request outputted from the emergency stop requesting unit; a movement permission cancellation unit which determines whether or not to cancel the movement permission for the mobile object, on the basis of the mobile object state information and the movement permission outputted from the movement permission determination unit; and a mobile object control unit which controls movement of the mobile object on the basis of the movement permission outputted from the movement permission determination unit and the movement permission cancellation outputted from the movement permission cancellation unit. In a case where the emergency stop request is outputted from the emergency stop requesting unit, the movement permission determination unit outputs the movement permission for the mobile object. In a case where output from the movement permission determination unit is the movement permission and output from the movement permission cancellation unit is not the cancellation, the mobile object control unit performs control so as to move the mobile object. In a case where output from the movement permission determination unit is not the movement permission or output from the movement permission cancellation unit is the cancellation, the mobile object control unit performs control so as to stop the mobile object.

According to the present disclosure, it becomes possible to execute emergency evacuation for ensuring safety of an own vehicle without obstructing advancement of another traffic participant.

### BRIEF DESCRIPTION OF THE DRAWINGS

FIG. 1 is a function block diagram showing the configurations of an emergency evacuation device and a mobile object control system according to the first embodiment of the present disclosure;

FIG. 2 shows the configurations of detection units for respective kinds of information used in the mobile object control system according to the first embodiment;

FIG. 3 shows an example of detection ranges for an obstacle by obstacle information detection units mounted to a vehicle;

FIG. 4 is a flowchart showing operation of the emergency evacuation device according to the first embodiment;

FIG. 5 is a function block diagram showing the configuration of a mobile object control unit of the emergency evacuation device according to the first embodiment;

FIG. 6 is a function block diagram showing the configurations of an emergency evacuation device and a mobile object control system according to the second embodiment of the present disclosure;

FIG. 7 shows the configurations of detection units for respective kinds of information used in the mobile object control system according to the second embodiment;

FIG. 8 illustrates operation of the emergency evacuation device according to the second embodiment;

FIG. 9A is a flowchart showing operation of the emergency evacuation device according to the second embodiment;

FIG. 9B is a flowchart showing operation of the emergency evacuation device according to the second embodiment;

FIG. 10 shows an example of a hardware configuration example of the mobile object control system according to each of the first and second embodiments; and

FIG. 11 shows another example of a hardware configuration of the mobile object control system according to each of the first and second embodiments.

### DETAILED DESCRIPTION OF THE PREFERRED EMBODIMENTS OF THE INVENTION

Hereinafter, embodiments of an emergency evacuation device, a mobile object control system, and an emergency evacuation method according to the present disclosure will be described with reference to the drawings. In the following embodiments, an automobile is used as an example of a mobile object to which the emergency evacuation device and the mobile object control system are applied, and an example in which an emergency evacuation plan for the own vehicle is generated is shown. The mobile object is assumed to be capable of traveling by automated driving corresponding to level 3 or level 4 defined by Society of Automotive Engineers (SAE) International, for example. It is assumed that the mobile object has acquired a traveling route to a destination in advance and is traveling along the route. In the drawings, the same reference characters denote the same or corresponding parts. Therefore, the detailed description thereof may be omitted to avoid repeating the description.

The drawings are shown in a schematic way, and for convenience of description, some components are omitted or simplified as appropriate. The mutual relationship of sizes and positions of components and the like shown in different drawings are not necessarily shown precisely, and may be changed as appropriate. Also in drawings such as a plan view other than a sectional view, hatching may be applied for facilitating the understanding of contents of the embodiments.

### First Embodiment

Hereinafter, an emergency evacuation device, a mobile object control system, and an emergency evacuation method according to the first embodiment of the present disclosure will be described with reference to the drawings.

<Device configurations>

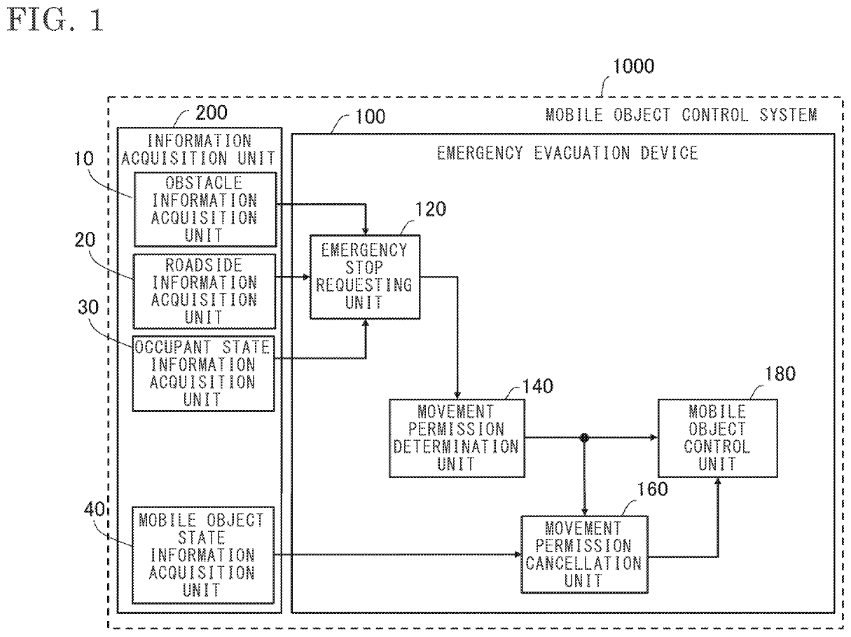

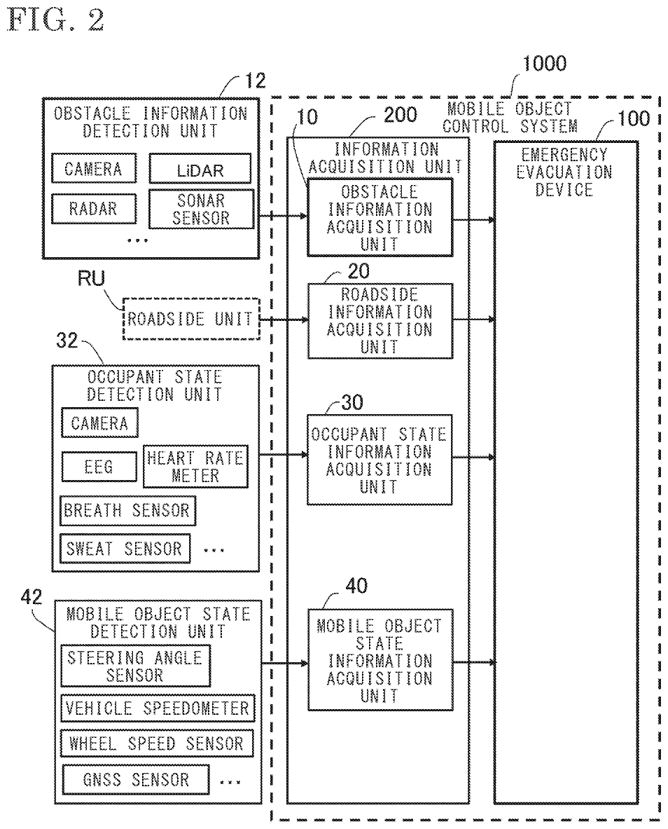

FIG. 1 is a function block diagram showing the configurations of the emergency evacuation device and the mobile object control system according to the first embodiment, and FIG. 2 is a diagram further including function blocks showing the configurations of detection units for respective kinds of information used in the mobile object control system in FIG. 1. In FIG. 1 and FIG. 2, the mobile object control system 1000 includes the emergency evacuation device 100. The emergency evacuation device 100 is a device for performing emergency evacuation of an own vehicle, and includes an emergency stop requesting unit 120, a movement permission determination unit 140 which determines whether or not to permit movement of the mobile object, a movement permission cancellation unit 160 which cancels movement permission for the mobile object, and a mobile object control unit 180 for driving the mobile object. The mobile object control system 1000 includes an information acquisition unit 200 which acquires necessary information for performing emergency evacuation of the own vehicle in the emergency evacuation device 100. The information acquisition unit 200 includes an obstacle information acquisition unit 10 which acquires information about an obstacle around the own vehicle, a roadside information acquisition unit 20 which acquires information from a roadside unit RU, an occupant state information acquisition unit 30 which acquires the state of an occupant who drives the own vehicle which is the mobile object, and a mobile object state information acquisition unit 40 which acquires information of the own vehicle from sensors mounted to the own vehicle which is the mobile object.

In FIG. 1 and FIG. 2, the obstacle information acquisition unit 10, the roadside information acquisition unit 20, the occupant state information acquisition unit 30, and the mobile object state information acquisition unit 40 may be included in the emergency evacuation device 100.

The obstacle information acquisition unit 10 acquires information of an obstacle present around the own vehicle, detected from an obstacle information detection unit 12.

The obstacle information detection unit 12 detects obstacle information. Obstacles are, for example, traffic participants such as another vehicle, a pedestrian, a bicycle, and a motorcycle present around the own vehicle. The obstacle information detection unit 12 is at least one of a camera, a radar, a light detection and ranging (LiDAR) device, and a sonar sensor (ultrasonic sensor) provided to the own vehicle, for example. The obstacle information detection unit 12 may output, to the obstacle information acquisition unit 10, obstacle information in which an obstacle present around the own vehicle is associated with the type of the traffic participant classified into another vehicle, a pedestrian, a bicycle, a motorcycle, or the like.

The cameras are provided at such positions that the cameras can take images in frontward, lateral, and rearward directions from the own vehicle. From the taken images, information indicating the environment around the vehicle, such as information of obstacles and lanes frontward of the own vehicle, is acquired.

The radar radiates a radar wave frontward of the own vehicle and detects a reflected wave thereof, thereby measuring a relative distance and a relative speed of an obstacle present frontward of the own vehicle, and outputs the measurement result.

The LiDAR device radiates a laser beam to an area around the own vehicle and detects a time difference until the laser beam is reflected and returns from a surrounding object, thereby detecting the position of the object.

The sonar sensor radiates an ultrasonic wave to an area around the own vehicle and detects a time difference until the ultrasonic wave is reflected and returns from a surrounding object, thereby detecting the position and the distance at which the object is present.

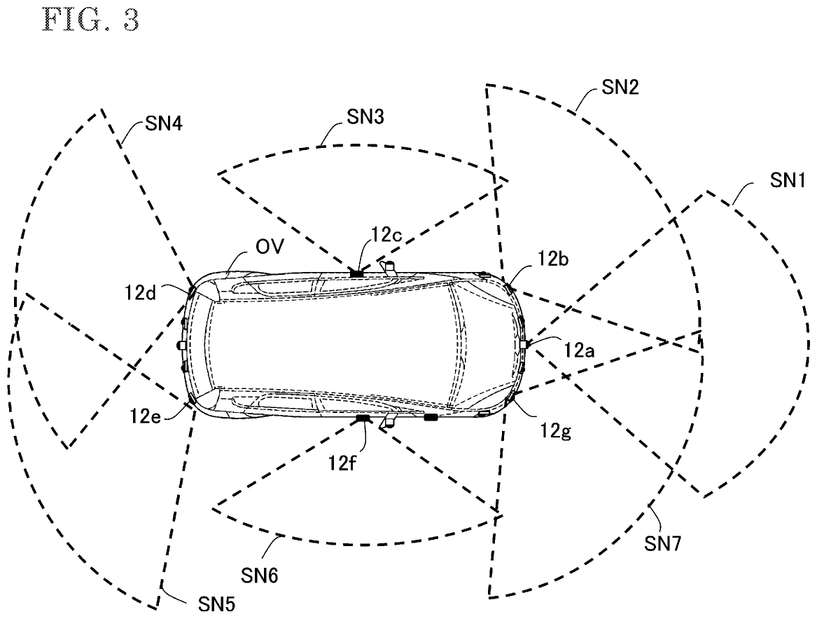

FIG. 3 shows an example in which a plurality of the obstacle information detection units 12 described above are combined and provided to the vehicle, and shows detection ranges of the respective obstacle information detection units 12. In FIG. 3, seven obstacle information detection units 12, i.e., obstacle information detection units 12a to 12g, are mounted to the own vehicle OV, three obstacle information detection units 12a, 12b, 12g are located on the front side, two obstacle information detection units 12c, 12f are located on the lateral sides, and two obstacle information detection units 12d, 12e are located on the rear side. The detection ranges of the respective obstacle information detection units 12 are shown by sector-shaped broken lines. The own vehicle OV can detect obstacles in detection ranges SN1, SN2, SN7 in the frontward area, detection ranges SN3, SN6 in the lateral areas, and detection ranges SN4, SN5 in the rearward area. As described above, it is desirable that the detection ranges for obstacles can be set so as to cover the whole surrounding area around the own vehicle OV.

For example, an obstacle information detection device (hereinafter, referred to as roadside unit) provided in a roadside area includes at least one of a camera, a radar, a LiDAR device, and a sonar sensor. The roadside information acquisition unit 20 acquires information around the roadside detected by the roadside unit RU, as obstacle information, via wireless communication. As well as in a roadside area, the roadside unit may be provided at a road such as a lane, a road shoulder, or a pavement, or may be provided to a building, a utility pole, or the like near a road. In addition, information around the roadside may be acquired from a remote traffic control system or the like.

An occupant state detection unit 32 detects a physiological state of an occupant. Examples of physiological states of an occupant include changes in eye gaze, blinking, and face orientation, brain waves, heart rate, exhaled air composition, and sweating amount of the occupant. The occupant state detection unit 32 is at least one of a camera, an electroencephalograph (EEG), a heart rate meter, a breath sensor, and a sweat sensor provided to the own vehicle, for example. The occupant state detection unit 32 outputs a physiological state and physical condition abnormality of the occupant to the occupant state information acquisition unit 30.

A mobile object state detection unit 42 detects a control state of the mobile object. Examples of control states of the mobile object include the steering angle, the steering speed, the speed, and the movement distance of the mobile object. The mobile object state detection unit 42 is at least one of a steering angle sensor, a vehicle speedometer, a wheel speed sensor, and a global navigation satellite system (GNSS) sensor. The mobile object state detection unit 42 outputs such a control state of the mobile object to the mobile object state information acquisition unit 40.

In FIG. 1, it has been described that the obstacle information acquisition unit 10 and the roadside information acquisition unit 20 may be included in the emergency evacuation device 100, but they may not necessarily be included in the emergency evacuation device 100. Also, the mobile object control unit 180 may not necessarily be included in the emergency evacuation device 100. As an example, in remote control for the own vehicle by traffic control, a configuration including the emergency stop requesting unit 120, the movement permission determination unit 140, and the movement permission cancellation unit 160, and a configuration including the obstacle information acquisition unit 10, the roadside information acquisition unit 20, the occupant state information acquisition unit 30, the mobile object state information acquisition unit 40, and the mobile object control unit 180, may be provided separately from each other. Specifically, the obstacle information acquisition unit 10, the roadside information acquisition unit 20, the occupant state information acquisition unit 30, the mobile object state information acquisition unit 40, and the mobile object control unit 180 are provided in the own vehicle, and the emergency stop requesting unit 120, the movement permission determination unit 140, and the movement permission cancellation unit 160 are provided on the traffic control side, as the emergency evacuation device 100. Without limitation thereto, the configurations may be reverse to each other, for example.

<Functions of Emergency Evacuation Device 100>

The emergency stop requesting unit 120 detects abnormality on the basis of obstacle information around the own vehicle acquired from the obstacle information acquisition unit 10, obstacle information around a roadside acquired from the roadside information acquisition unit 20, and information of the physiological state of the occupant acquired from the occupant state information acquisition unit 30. Then, if abnormality is detected, the emergency stop requesting unit 120 outputs an emergency stop request.

Here, an example of a method for detecting abnormality will be described.

First, an example about abnormality for obstacle information acquired from the roadside information acquisition unit 20 will be described. As abnormality for obstacle information acquired from the roadside information acquisition unit 20, there is communication disruption. Whether or not communication disruption has occurred can be determined by providing a signal counted up per certain cycle from a roadside unit RU to the roadside information acquisition unit 20. The reason is that, if an event in which count-up per certain cycle is not done is detected, this can be considered to mean that communication from the roadside unit RU to the roadside information acquisition unit 20 is disrupted. In this way, the emergency stop requesting unit 120 determines communication disruption on the basis of obstacle information acquired from the roadside information acquisition unit 20, thus detecting abnormality.

Next, an example about abnormality for obstacle information acquired from the obstacle information detection unit 12 provided to the own vehicle will be described. As abnormality for obstacle information acquired from the obstacle information detection unit 12, there are communication disruption and reduction in the detection range. Communication disruption can be determined by using a signal counted up per certain cycle, whereby abnormality can be detected, as in the case where communication from the roadside unit RU to the roadside information acquisition unit 20 is disrupted.

Regarding whether or not the detection range is reduced, snow or the like may be adhered around the sensor which is the obstacle information detection unit 12, and the detection range reduction can be determined by confirming whether or not a state in which the measurement distance is not greater than a predetermined threshold has been detected for a predetermined period. That is, in a case where snow or the like is adhered so as to cover a part of the sensor, the detection range is reduced as compared to the normal range, and thus abnormality can be detected. As another example, it is assumed that some of imaging elements of the camera fail, so that some pixels of the camera image have no colors or have not changed in colors for a predetermined period. Thus, the detection range is reduced and abnormality can be detected.

Next, an example about abnormality for the occupant physiological state acquired from the occupant state information acquisition unit 30 provided to the own vehicle will be described. As abnormality for the occupant physiological state acquired from the occupant state information acquisition unit 30, there is communication disruption. Communication disruption can be determined by using a signal counted up per certain cycle, whereby abnormality can be detected, as with the communication disruption from the roadside unit RU to the roadside information acquisition unit 20. Also, there are abnormality and deterioration of the occupant physiological state other than device abnormality like communication disruption of the occupant state information acquisition unit 30. Such abnormality of the occupant physiological state can be detected on the basis of occupant physiological states such as changes in eye gaze, blinking, and face orientation, brain waves, heart rate, exhaled air composition, and sweating amount of the occupant, and predetermined indices indicating abnormality and deterioration of occupant physiological states.

The movement permission determination unit 140 determines whether or not to permit a traffic participant to move the own vehicle which is the mobile object, on the basis of an emergency stop request outputted from the emergency stop requesting unit 120. In a case where movement is permitted, the occupant who is a driver of the mobile object is permitted to arbitrarily move the mobile object, i.e., the own vehicle, in order to reduce obstruction to advancement of another traffic participant. Thus, it is possible to manually cope with even a case where the mobile object stops in emergency by automated traveling at an inappropriate position where passage of a traffic participant is obstructed. A person who moves the own vehicle under permission is not limited to the driver or the occupant of the mobile object. For example, a third person corresponding to another traffic participant such as another vehicle, a pedestrian, a bicycle, or a motorcycle present around the own vehicle may move the own vehicle. In a case where the own vehicle is under unmanned dispatch, even if the driver or the occupant of the own vehicle cannot move the own vehicle, another person may move the own vehicle so that passage of an emergency vehicle or the like is not obstructed and obstruction to passage of another traffic participant is reduced.

The movement permission cancellation unit 160 determines whether or not to cancel permission of manual movement of the mobile object, on the basis of a control state of the mobile object acquired from the mobile object state information acquisition unit 40 and a movement permission state outputted from the movement permission determination unit 140. In a case where the permission is canceled, the mobile object becomes unable to be moved.

Specifically, in a case where at least one of a state in which the steering angle or the steering speed of the mobile object is greater than a predetermined value, a state in which the speed of the mobile object is greater than a predetermined value, and a state in which the movement distance of the mobile object after movement permission is greater than a predetermined value, is satisfied, it is determined that a movement permission cancellation condition is satisfied, and thus movement permission for the mobile object is canceled. That is, even when the mobile object is permitted to be moved, the steering angle, the steering speed, the speed of the mobile object, and the movement distance thereof are limited to predetermined values or less. Therefore, even if a person who moves the mobile object permitted to be moved is not the driver or the occupant of the mobile object but a third person who does not normally use the mobile object, the third person can move the mobile object appropriately and safely. In addition, since the speed of the mobile object, the movement distance thereof, and the like are limited, the mobile object cannot be moved far from a position evacuated from an area such as an intersection where the mobile object obstructs passage of a traffic participant. Therefore, even if a malicious third person attempts to move the mobile object permitted to be moved, it is possible to prevent such a behavior as to steal the mobile object.

The mobile object control unit 180 controls the mobile object so that the own vehicle which is the mobile object can be manually moved arbitrarily within a certain limited range, on the basis of a movement permission state outputted from the movement permission determination unit 140 and a movement permission cancellation state outputted from the movement permission cancellation unit 160.

<Operations of Mobile Object Control System 1000 and Emergency Evacuation Device 100>

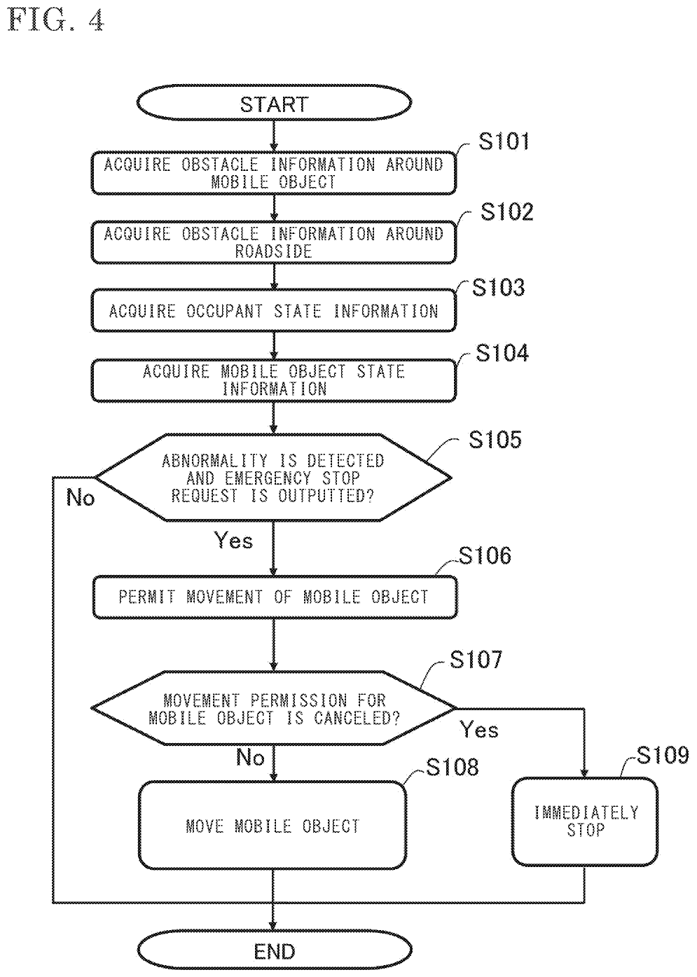

Next, operations of the mobile object control system 1000 and the emergency evacuation device 100 according to the first embodiment will be described with reference to a flowchart in FIG. 4. The process in the flowchart shown in FIG. 4 is repeatedly executed during traveling of the own vehicle which is the mobile object. Steps in FIG. 4 will be described in association with the function units shown in the function block diagrams in FIG. 1 and FIG. 2.

First, in step S101, the obstacle information acquisition unit 10 acquires information of an obstacle present around the own vehicle which is the mobile object, outputted from the obstacle information detection unit 12.

In step S102, the roadside information acquisition unit 20 acquires obstacle information around a roadside, outputted from a roadside unit RU.

In step S103, the occupant state information acquisition unit 30 acquires occupant state information including a physiological state of the occupant, outputted from the occupant state detection unit 32.

In step S104, the mobile object state information acquisition unit 40 acquires a state of the mobile object and a control state thereof, outputted from the mobile object state detection unit 42.

In step S105, the emergency stop requesting unit 120 detects whether or not abnormality has occurred for any of the obstacle information outputted from the obstacle information acquisition unit 10, the obstacle information outputted from the roadside information acquisition unit 20, and the occupant physiological state outputted from the occupant state information acquisition unit 30, and when having detected abnormality for at least any of them, the emergency stop requesting unit 120 outputs an emergency stop request. If abnormality is detected and an emergency stop request is outputted (Yes in step S105), the process proceeds to step S106. If abnormality is not detected, an emergency stop request is not outputted (No in step S105) and therefore traveling while following the route on which the own vehicle is traveling at present (automated traveling) is continued.

In step S106, the movement permission determination unit 140 determines whether or not the own vehicle which is the mobile object may be manually moved, on the basis of the emergency stop request outputted from the emergency stop requesting unit 120. In a case where the emergency stop request is outputted from the emergency stop requesting unit 120, movement of the own vehicle which is the mobile object is permitted and then the process proceeds to step S107.

If the process proceeds to step S107, the movement permission cancellation unit 160 determines whether or not to cancel permission of manual movement for the own vehicle which is the mobile object, on the basis of the control state of the mobile object outputted from the mobile object state information acquisition unit 40 and the movement permission state outputted from the movement permission determination unit 140. This determination is performed on the basis of the movement permission cancellation condition described above. If the movement permission cancellation condition is not satisfied (No in step S107), the process proceeds to step S108. If the movement permission cancellation condition is satisfied (Yes in step S107), the process proceeds to step S109.

If the process proceeds to step S108, the mobile object control unit 180 controls the mobile object so that the occupant who is the driver of the mobile object or a third person corresponding to another traffic participant can arbitrarily move the own vehicle which is the mobile object within a certain limited range.

If the process proceeds to step S109, the mobile object control unit 180 performs control so as to immediately stop the own vehicle which is the mobile object. This step S109 serves to prevent inappropriate and unsafe manual movement of the mobile object, and also serves to prevent the own vehicle from being stolen.

<Control Process by Mobile Object Control Unit 180>

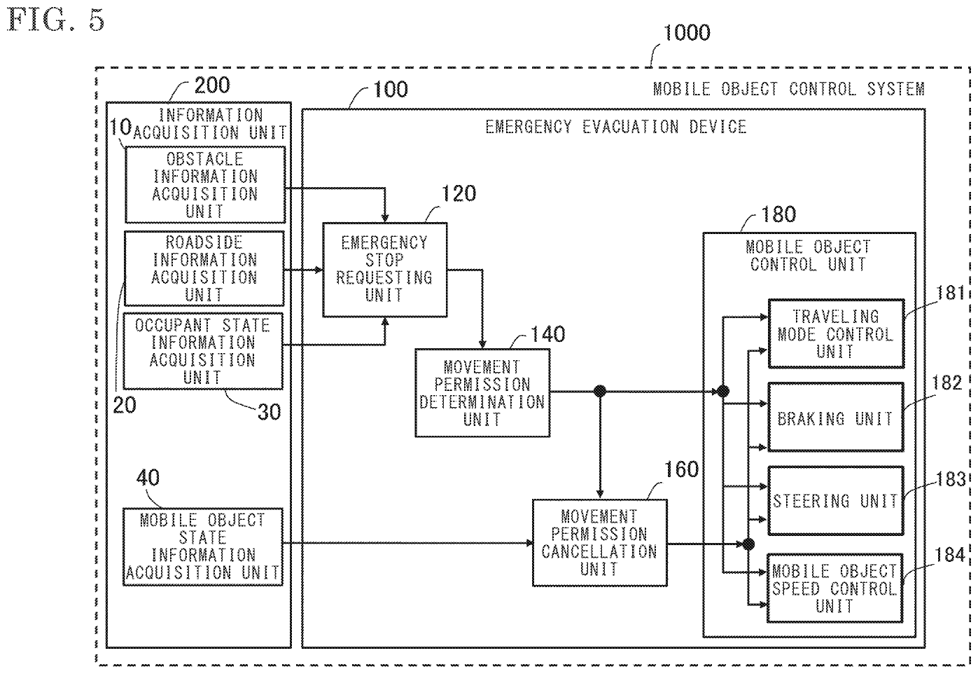

Next, control of the mobile object by the mobile object control unit 180 will be described. FIG. 5 shows the configuration of the mobile object control unit 180 in FIG. 1 and is a function block diagram of the mobile object control unit 180. As shown in FIG. 5, the mobile object control unit 180 includes a traveling mode control unit 181, a braking unit 182, a steering unit 183, and a mobile object speed control unit 184.

In a state in which movement is permitted in accordance with output of the movement permission determination unit 140 and output of the movement permission cancellation unit 160, the traveling mode control unit 181 sets the traveling mode of the mobile object to a limited manual traveling mode. In a state in which movement is not permitted, the traveling mode control unit 181 sets the traveling mode of the mobile object to an emergency stop mode. Thus, even when an emergency stop request is outputted from the emergency stop requesting unit 120, if the movement permission determination unit 140 permits movement (allows movement), the traveling mode becomes the limited manual traveling mode, and therefore the occupant who is the driver of the mobile object, etc., can arbitrarily move the mobile object within a certain limited range.

In a state in which movement is permitted in accordance with output of the movement permission determination unit 140 and output of the movement permission cancellation unit 160, the braking unit 182 releases braking means. In a state in which movement is not permitted, the braking unit 182 activates the braking means. Thus, even when an emergency stop request is outputted from the emergency stop requesting unit 120, if the movement permission determination unit 140 permits movement (allows movement), the occupant who is the driver of the mobile object, etc., can arbitrarily move the mobile object of which the braking means is released, by pushing or towing the mobile object.

The braking unit 182 may control the braking means in coordination with manual operation by the occupant who is the driver, etc. For example, when movement is permitted, the braking unit 182 may activate the braking means, and thereafter, if the occupant who is the driver, etc., manually performs release operation of the braking means, the braking unit 182 may release the braking means. Further, after the braking unit 182 releases the braking means, if the occupant who is the driver, etc., manually performs activation operation of the braking means at least once, the braking unit 182 continues activation of the braking means.

By controlling the braking means through coordination between the braking unit 182 and manual operation by the occupant who is the driver, etc., it becomes possible to, for example, on an ascending/descending slope, prevent the mobile object from moving by itself downward on the slope, by activation of the braking means, and also prevent obstruction to passage by the occupant arbitrarily moving the mobile object, for example. That is, it is assumed that, when an emergency stop request is outputted and then movement permission is outputted, the own vehicle may be around an ascending/descending slope. In this case, if the braking unit 182 releases the braking means, the own vehicle moves along the slope. However, even when movement permission is outputted, if the braking unit 182 releases the braking means in coordination with release operation of the braking means by the occupant, etc., it is possible to prevent movement of the own vehicle. In addition, after a third person in good faith prevents obstruction to passage, the braking means is operated to be activated, thereby preventing a malicious third person from stealing the mobile object after that.

The mobile object control unit 180 may include at least one of the traveling mode control unit 181 and the braking unit 182.

In a state in which movement is permitted in accordance with output of the movement permission determination unit 140 and output of the movement permission cancellation unit 160, the steering unit 183 limits the steering angle or the steering speed of steering means to less than a predetermined value. Further, the steering unit 183 limits the steering angle or the steering speed to be reduced as the movement distance after movement permission increases.

In a state in which movement is permitted in accordance with output of the movement permission determination unit 140 and output of the movement permission cancellation unit 160, the mobile object speed control unit 184 limits an upper limit speed of mobile object speed control means to less than a predetermined value. Further, the mobile object speed control unit 184 limits the upper limit speed to be reduced as the movement distance after movement permission increases.

Through such control of the steering unit 183 and the mobile object speed control unit 184, the occupant who is the driver of the mobile object, etc., is allowed to move the mobile object to a minimum extent so as not to obstruct passage of another traffic participant, and the mobile object is prevented from being stolen.

The mobile object control unit 180 may include at least one of the steering unit 183 and the mobile object speed control unit 184.

As described above, according to the first embodiment, the emergency evacuation device includes the emergency stop requesting unit, the movement permission determination unit, the movement permission cancellation unit, and the mobile object control unit. The emergency stop requesting unit detects whether or not abnormality has occurred for any of obstacle information acquired from the obstacle information acquisition unit, obstacle information acquired from the roadside information acquisition unit, and an occupant physiological state acquired from the occupant state information acquisition unit, and if abnormality is detected, outputs an emergency stop request. The movement permission determination unit determines whether or not the occupant who is the driver of the mobile object, etc., may move the own vehicle which is the mobile object, on the basis of the emergency stop request. If movement is permitted, the movement permission cancellation unit determines whether or not to cancel permission of manual movement for the own vehicle which is the mobile object, on the basis of the control state of the mobile object acquired from the mobile object state information acquisition unit. Movement permission and cancellation of the movement permission are outputted to the mobile object control unit. Therefore, the mobile object can be controlled so that the occupant who is the driver of the mobile object, etc., can arbitrarily move the own vehicle which is the mobile object within a certain limited range. Thus, even when abnormality has occurred, it is possible to move the mobile object while ensuring safety of the own vehicle without obstructing advancement of another traffic participant.

### Second Embodiment

Hereinafter, an emergency evacuation device, a mobile object control system, and an emergency evacuation method according to the second embodiment of the present disclosure will be described with reference to the drawings.

The mobile object control system according to the second embodiment is configured by further including a road information acquisition unit and an own-position acquisition unit in the information acquisition unit. Description of the same configurations as those in the first embodiment is omitted.

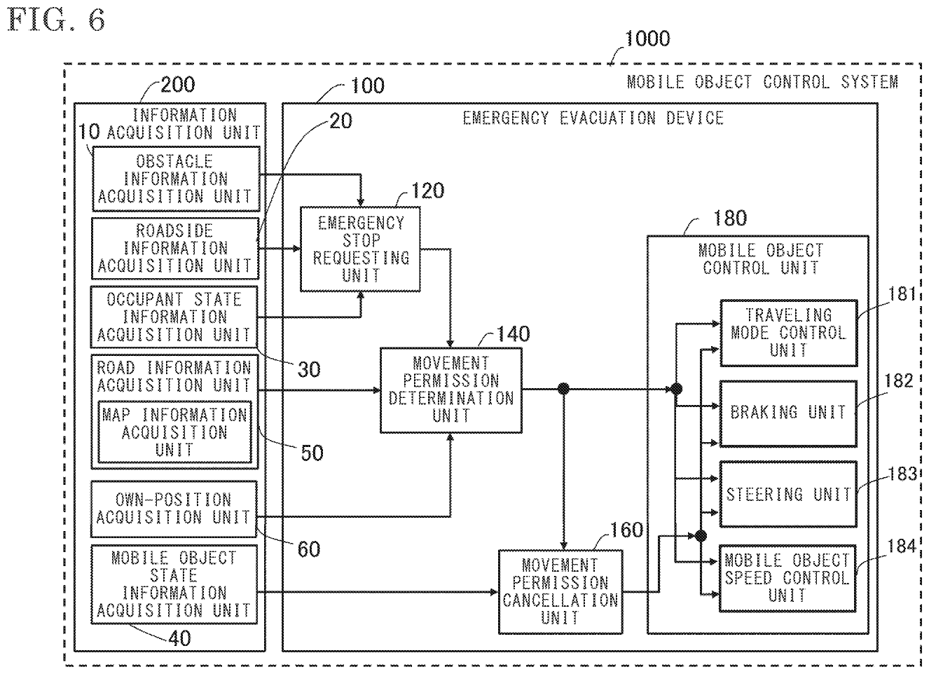

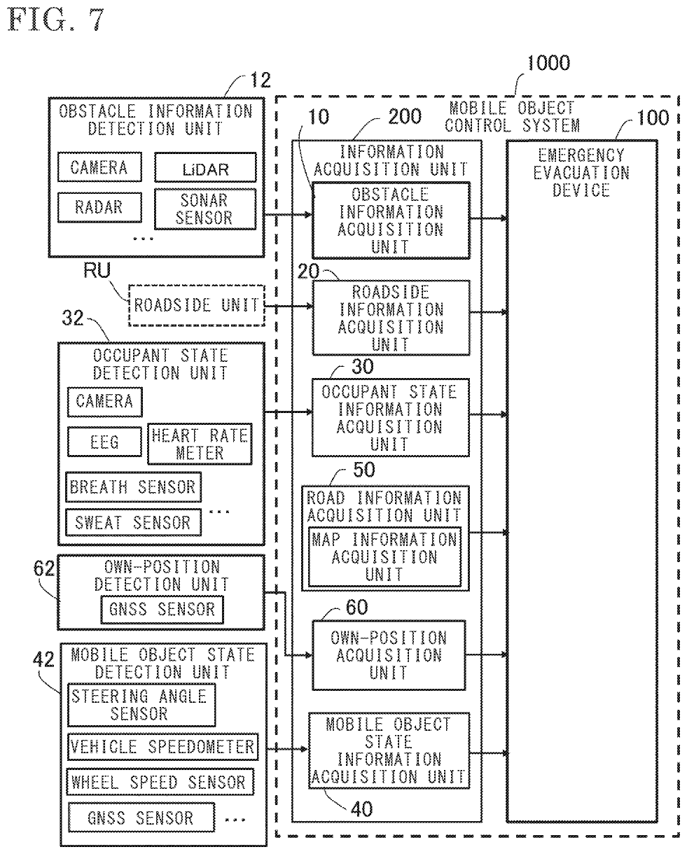

FIG. 6 is a function block diagram showing the configurations of the emergency evacuation device and the mobile object control system according to the second embodiment, and FIG. 7 is a diagram further including function blocks showing the configurations of detection units for respective kinds of information used in the mobile object control system in FIG. 6. In FIG. 6 and FIG. 7, the mobile object control system 1000 includes the emergency evacuation device 100.

As shown in FIG. 6 and FIG. 7, the emergency evacuation device further includes a road information acquisition unit 50 and an own-position acquisition unit 60 in addition to the configuration of the information acquisition unit 200 shown in the first embodiment. The movement permission determination unit 140 of the emergency evacuation device 100 determines whether or not to permit movement of the mobile object, considering also road information acquired by the road information acquisition unit 50 and the own position acquired from the own-position acquisition unit 60.

The road information acquisition unit 50 acquires information of roads around the own vehicle which is the mobile object from a road information detection unit (not shown).

The road information acquisition unit 50 includes a map information acquisition unit which has acquired map data of a planned traveling route for the own vehicle in advance, and acquires road information around the own vehicle on the basis of own-vehicle position information detected by an own-position detection unit 62.

Here, the map data includes road information made up of center lines of lanes on which the own vehicle travels, lane widths, stop lines of intersections, the numbers of branches of intersections such as a T junction and a crossroad, stop lines of intersections, and diverging start positions.

Road information to be included in the map data may be acquired from a surrounding structure detection result obtained from at least one of the camera, the radar, the LiDAR device, and the sonar sensor which are the obstacle information detection units 12 provided to the own vehicle.

The own vehicle is provided with a GNSS sensor as the own-position detection unit 62, in order to identify the position of the own vehicle. A GNSS antenna is connected to the GNSS sensor, and a positioning signal from a positioning satellite moving along a satellite orbit is received by the GNSS antenna. The received positioning signal is analyzed and information of the phase center of the GNSS antenna (such as latitude, longitude, altitude, and orientation) is outputted to the own-position acquisition unit 60.

The own position which is position information of the own vehicle may be acquired by, instead of the method using the GNSS sensor, simultaneous localization and mapping (SLAM) (simultaneous execution of own-position estimation and environment map generation) technology using a surrounding structure detection result acquired from at least one of the camera, the radar, the LiDAR device, and the sonar sensor.

The movement permission determination unit 140 determines whether or not the occupant who is the driver of the mobile object, etc., may move the mobile object, i.e., whether or not to permit movement, on the basis of an emergency stop request outputted from the emergency stop requesting unit 120, and further, the road information acquired from the road information acquisition unit 50 and the own-position information acquired from the own-position acquisition unit 60. Specifically, the movement permission determination unit 140 determines whether or not the mobile object will enter and stop in an area where another traffic participant is greatly influenced in a case where the mobile object stops from the present position in accordance with the emergency stop request.

Next, in the movement permission determination unit 140, for determining movement permission, a method for calculating the stop position regarding whether or not the own vehicle will stop in an area where another traffic participant is greatly influenced, will be described.

Here, as a method for calculating the stop position, the present position may be calculated directly as the stop position, or the stop position may be calculated using a deceleration that can be produced by the own vehicle in a case of stopping from the present vehicle speed, for example.

Whether or not the calculated stop position of the own vehicle is in an area where another traffic participant is greatly influenced is determined on the basis of the road information acquired by the road information acquisition unit 50. The area where another traffic participant is greatly influenced refers to a position where advancement of another traffic participant is obstructed when the own vehicle is stopped at the position, and specific examples thereof are an area on the inner side of stop lines of an intersection, a diverging start position on an expressway, and the like, i.e., an “area where roads intersect each other”. Hereinafter, the “area where another traffic participant is greatly influenced” is referred to as an “area where advancement of another traffic participant is obstructed”.

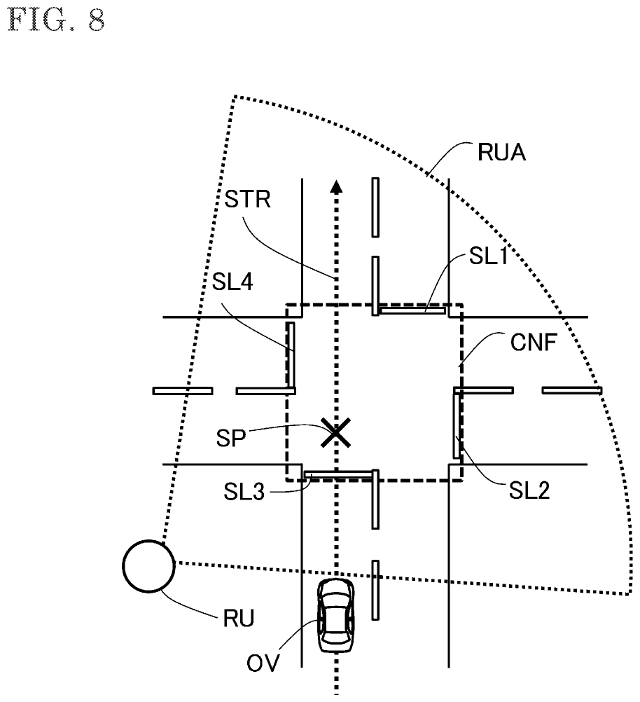

Next, an example of a method for determining whether or not the own vehicle will stop in an area where advancement of another traffic participant is obstructed, will be described with reference to FIG. 8. FIG. 8 illustrates operation of the emergency evacuation device 100 according to the second embodiment. In FIG. 8, the own vehicle OV traveling on the left side is about to enter an intersection, and a rectangular area indicated by a broken line connecting stop lines SL1, SL2, SL3, SL4 of lanes forming the intersection is an intersection area CNF. Here, the inner side of the stop lines SL1, SL2, SL3, SL4 of the intersection, i.e., the inside of the area CNF is an area where advancement of another traffic participant is obstructed. A roadside unit RU provided at a roadside can detect an obstacle in an area RUA indicated by a dotted-line sector shape.

First, position information of the stop lines SL1, SL2, SL3, SL4 forming the intersection is inputted from the road information acquisition unit 50 to the movement permission determination unit 140. By connecting pieces of position information of the stop lines SL1, SL2, SL3, SL4, the area CNF represented by a rectangular shape CNF can be generated. Then, if the stop position of the own vehicle OV is present inside the area CNF, it is determined that the own vehicle OV will stop in the area where advancement of another traffic participant is obstructed.

Next, the stop position of the own vehicle OV is calculated.

Center line information of the lane on which the own vehicle travels is acquired from the road information acquisition unit 50. Here, this information is assumed to be a straight route STR of a target route to be followed by the own vehicle. Then, the stop position of the own vehicle OV is represented by a stop position SP on the straight route STR in FIG. 8. The stop position SP of the own vehicle OV is calculated using the deceleration of the own vehicle OV on the straight route STR.

In FIG. 8, the gravity center position of the own vehicle OV at a time of stoppage is represented by the position SP. If this position is present in the intersection area CNF, it is determined that the own vehicle OV will enter the area where advancement of another traffic participant is obstructed at a time of stoppage.

The stop position SP may be any position that allows the own vehicle OV to be identified, such as the front end position or the rear end position of the own vehicle OV. Regarding whether or not the stop position SP is present in the area CNF, a rectangular shape according to the size of the own vehicle OV (a simulated outer shape of the own vehicle) may be generated from the position thereof (stop position), and if a part of the rectangular shape is present inside the intersection area CNF, it may be determined that the own vehicle OV will enter the area where advancement of another traffic participant is obstructed at a time of stoppage of the own vehicle OV.

In the above description, as the area where advancement of another traffic participant is obstructed, the area CNF corresponding to the intersection area is generated on the basis of the position information of the stop lines of the intersection inputted from the road information acquisition unit 50. However, the present disclosure is not limited thereto. As the area where advancement of another traffic participant is obstructed, the area CNF may be inputted to the movement permission determination unit 140 directly on the basis of information such as intersection information that the road information acquisition unit 50 has. As another example, using diverging start position information that the road information acquisition unit 50 has, an area including a diverging start position may be set as the area CNF. Thus, the area CNF may be set without limitation to the intersection area.

<Operations of Mobile Object Control System 1000 and Emergency Evacuation Device 100>

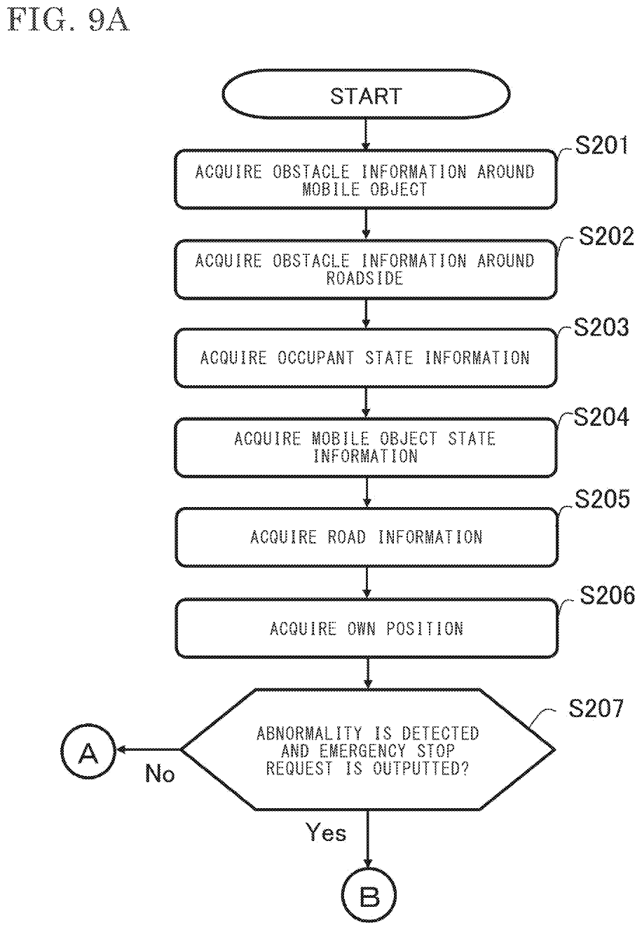

Next, operations of the mobile object control system 1000 and the emergency evacuation device 100 according to the second embodiment will be described with reference to flowcharts in FIG. 9A and FIG. 9B. The process in the flowcharts in FIG. 9A and FIG. 9B is repeatedly executed during traveling of the own vehicle. Steps in FIG. 9A and FIG. 9B will be described in association with the function units shown in FIG. 6 and FIG. 7. Processing in steps S201 to S204, S207, and S209 to S211 is the same as processing in steps S101 to S104, S105, and S107 to S109 in FIG. 4 in the first embodiment, and therefore description thereof is omitted.

In steps S201 to S204, the mobile object control system 1000 acquires each information, i.e., obstacle information around the mobile object, obstacle information around a roadside, occupant state information, and mobile object state information.

In step S205, the road information acquisition unit 50 acquires road information outputted from the road information detection unit (not shown) or road information of the map information acquisition unit.

In step S206, the own-position acquisition unit 60 acquires the own position which is position information of the mobile object from the own-position detection unit 62.

In step S207, the emergency stop requesting unit 120 detects whether or not abnormality has occurred for any of the obstacle information around the mobile object outputted from the obstacle information acquisition unit 10, the obstacle information around the roadside outputted from the roadside information acquisition unit 20, and the occupant physiological state outputted from the occupant state information acquisition unit 30, and when having detected abnormality for at least any of them, the emergency stop requesting unit 120 outputs an emergency stop request. If abnormality is detected and an emergency stop request is outputted (Yes in step S207), the process proceeds to step S208. If abnormality is not detected, an emergency stop request is not outputted (No in step S207) and therefore traveling while following the route on which the own vehicle is traveling at present (automated traveling) is continued.

In step S208, whether or not the occupant who is the driver of the mobile object, etc., may move the mobile object, i.e., whether or not to permit movement, is determined on the basis of the emergency stop request outputted from the emergency stop requesting unit 120, the road information acquired from the road information acquisition unit 50, and the own-position information acquired from the own-position acquisition unit 60. For determining whether or not to permit movement, the movement permission determination unit 140 calculates the stop position regarding whether or not the own vehicle will stop in the area where advancement of another traffic participant is obstructed. If the calculated stop position is in the area CNF which is the area where advancement of another traffic participant is obstructed, the movement permission determination unit 140 outputs movement permission for the mobile object (Yes in step S208), thus proceeding to step S209. If the calculated stop position is not in the area CNF, the movement permission determination unit 140 does not output movement permission (No in step S208), thus proceeding to step S211.

If the process proceeds to step S209, the movement permission cancellation unit 160 determines whether or not to cancel permission of movement of the own vehicle which is the mobile object for the occupant who is the driver of the mobile object, etc., on the basis of the control state of the mobile object outputted from the mobile object state information acquisition unit 40 and the movement permission state outputted from the movement permission determination unit 140. The determination is performed on the basis of the movement permission cancellation condition described in the first embodiment. If the movement permission cancellation condition is not satisfied (No in step S209), the process proceeds to step S210. If the movement permission cancellation condition is satisfied (Yes in step S209), the process proceeds to step S211.

If the process proceeds to step S210, the mobile object control unit 180 controls the mobile object so that the occupant who is the driver of the mobile object, etc., can arbitrarily move the own vehicle which is the mobile object within a certain limited range.

If the process proceeds to step S211, the mobile object control unit 180 performs control so as to immediately stop the own vehicle which is the mobile object. This step S211 serves to prevent inappropriate and unsafe manual movement of the mobile object.

<Control Process by Mobile Object Control Unit 180>

Next, control of the mobile object by the mobile object control unit 180 will be described. As shown in FIG. 6 and FIG. 7, the configuration of the mobile object control unit 180 according to the second embodiment is the same as the configuration of the mobile object control unit 180 according to the first embodiment shown in FIG. 5. Therefore, the mobile object control unit 180 performs control of each driving system element of the mobile object in accordance with whether or not movement can be permitted on the basis of output signals from the movement permission determination unit 140 and the movement permission cancellation unit 160. As in the first embodiment, the mobile object control unit 180 may include at least one of the traveling mode control unit 181 and the braking unit 182. In addition, the mobile object control unit 180 may include at least one of the steering unit 183 and the mobile object speed control unit 184.

In a state in which movement is permitted in accordance with output of the movement permission determination unit 140 and output of the movement permission cancellation unit 160, the traveling mode control unit 181 sets the traveling mode of the mobile object to a limited manual traveling mode. In a state in which movement is not permitted, the traveling mode control unit 181 sets the traveling mode of the mobile object to an emergency stop mode. Thus, even when an emergency stop request is outputted from the emergency stop requesting unit 120, if the movement permission determination unit 140 permits movement (allows movement), the traveling mode becomes the limited manual traveling mode, and therefore the occupant who is the driver of the mobile object, etc., can arbitrarily move the mobile object within a certain limited range. Thus, in addition to the effects in the first embodiment, the mobile object can be stopped while avoiding the inside of the area CNF which is the area where advancement of another traffic participant is obstructed.

In a state in which movement is permitted in accordance with output of the movement permission determination unit 140 and output of the movement permission cancellation unit 160, the braking unit 182 releases braking means. In a state in which movement is not permitted, the braking unit 182 activates the braking means. Thus, even when an emergency stop request is outputted from the emergency stop requesting unit 120, if the movement permission determination unit 140 permits movement (allows movement), the occupant who is the driver of the mobile object can arbitrarily move the mobile object of which the braking means is released, by pushing or towing the mobile object. Thus, in addition to the effects in the first embodiment, the mobile object can be stopped while avoiding the inside of the area CNF which is the area where advancement of another traffic participant is obstructed.

The braking unit 182 may control the braking means in coordination with manual operation by the occupant who is the driver, etc. Also in this case, the same effects as in the first embodiment are provided.

In a state in which movement is permitted in accordance with output of the movement permission determination unit 140 and output of the movement permission cancellation unit 160, the steering unit 183 limits the steering angle or the steering speed of steering means to less than a predetermined value. Further, the steering unit 183 limits the steering angle or the steering speed to be reduced as the movement distance after movement permission increases.

In a state in which movement is permitted in accordance with output of the movement permission determination unit 140 and output of the movement permission cancellation unit 160, the mobile object speed control unit 184 limits an upper limit speed of mobile object speed control means to less than a predetermined value. Further, the mobile object speed control unit 184 limits the upper limit speed to be reduced as the movement distance after movement permission increases.

Through such control of the steering unit 183 and the mobile object speed control unit 184, the occupant who is the driver of the mobile object is allowed to move the mobile object to a minimum extent so as not to obstruct passage of another traffic participant, and the mobile object can be stopped while avoiding the inside of the area CNF which is the area where advancement of another traffic participant is obstructed.

As described above, according to the second embodiment, the same effects as in the first embodiment are provided. That is, even when abnormality has occurred, the mobile object can be controlled so that the occupant who is the driver of the mobile object, etc., can arbitrarily move the own vehicle which is the mobile object within a certain limited range. Thus, it is possible to ensure safety of the own vehicle without obstructing advancement of another traffic participant.

Further, when abnormality has occurred, the movement permission determination unit calculates the stop position regarding whether or not the own vehicle will stop in the area where advancement of another traffic participant is obstructed, and if the calculated stop position is in an area where advancement of another traffic participant is obstructed, the movement permission determination unit outputs movement permission for the mobile object. Thus, it is possible to stop the mobile object while avoiding the area where advancement of another traffic participant is obstructed.

Also in the second embodiment, a person who moves the mobile object is not limited to the occupant who is the driver of the mobile object, as described in the first embodiment.

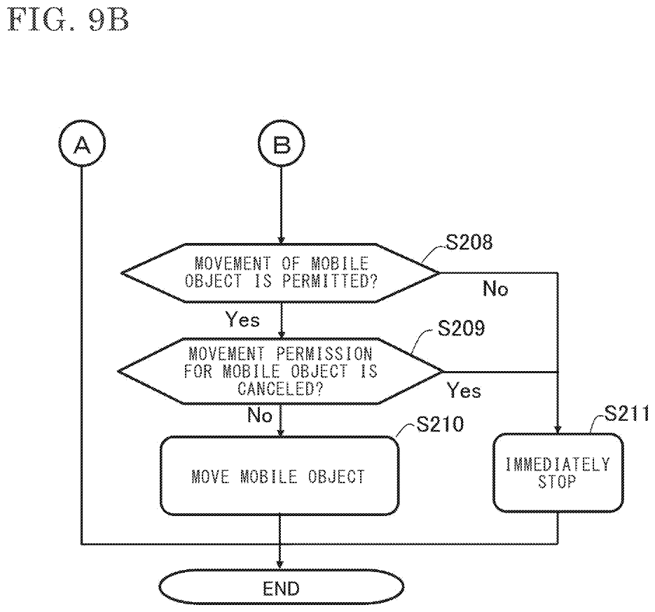

The function units of the emergency evacuation device 100 according to each of the first and second embodiments may be implemented by a hardware configuration of the mobile object control system 1000 exemplified in FIG. 10, which is composed of a processing circuit 1001, a storage device 1002 including a read only memory (ROM) storing a program for executing the functions of the function units and a random access memory (RAM) storing data of execution results of the function units which are calculation results by the program, and an input/output circuit 1003. The input/output circuit 1003 receives output results about obstacle information from each obstacle information detection unit 12 which is the obstacle detection sensor provided to the own vehicle, output results about own-position information detected by the own-position detection unit 62 and obstacle information from the roadside unit RU, and the like. Then, control signals for the speed of the own vehicle, steering, and the like are outputted from the input/output circuit 1003 to drive-system equipment 2000 which includes the actuators for driving the vehicle, such as the brake (braking means) and the steering wheel (steering means).

For the processing circuit 1001, a processor such as a central processing unit (CPU) or a digital signal processor (DSP) is used. Dedicated hardware may be used for the processing circuit 1001. In a case where the processing circuit 1001 is dedicated hardware, the processing circuit 1001 is, for example, a single circuit, a complex circuit, a programmed processor, a parallel-programmed processor, an application specific integrated circuit (ASIC), a field-programmable gate array (FPGA), or a combination thereof.

The function units of the emergency evacuation device 100 and the mobile object control system 1000 may be each implemented by an individual processing circuit, or may be collectively implemented by one processing circuit.

Regarding the function units of the emergency evacuation device 100 and the mobile object control system 1000, some of the functions may be implemented by a processing circuit as dedicated hardware, and other functions may be implemented by software, for example. Thus, the functions described above may be implemented by hardware, software, etc., or a combination thereof.

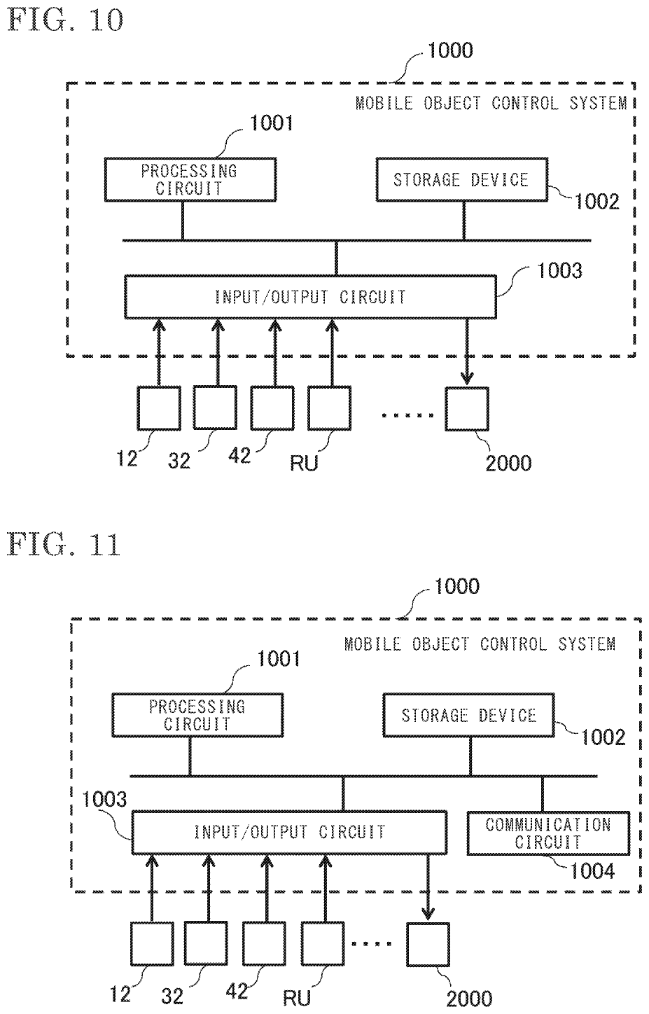

FIG. 11 shows another example of a hardware configuration of the mobile object control system 1000. A communication circuit 1004 is further provided in addition to the configuration in FIG. 10.

The communication circuit 1004 includes a long-range communication unit and a short-range communication unit as a communication module. As the long-range communication unit, the one compliant with a predetermined long-range wireless communication standard such as long term evolution (LTE) or fourth/fifth-generation mobile communication system (4G/5G) is used. For the short-range communication unit, for example, dedicated short range communications (DSRC) are used, and although not shown in the above embodiments, the short-range communication unit may be used for communication with another vehicle, whereby information of another vehicle around the own vehicle can be acquired. For these communications, certain communication speeds are ensured.

The roadside unit RU is provided outside the mobile object or outside a traffic control system, and therefore obstacle information from the roadside unit RU is received through communication by the mobile object control system 1000. For this communication, LTE or 5G is used, for example.

Each sensor of the obstacle information detection unit 12, each sensor of the occupant state detection unit 32, and each sensor of the mobile object state detection unit 42 are mounted to the mobile object, and information from each sensor is outputted to the information acquisition unit 200 via a communication line. For example, they are connected using Controller Area Network (CAN) (registered trademark).

Also in a case where a part of the mobile object control system 1000 is present outside the own vehicle, e.g., in a traffic control system, and emergency stop is activated, transmission and reception of signals are performed by the communication circuit 1004.

### Other Embodiments

In the above description, the case where the mobile object to which the emergency evacuation device 100 and the mobile object control system 1000 are applied is an automobile which is a vehicle, has been shown as an example. However, the application target is not limited to an automobile, and may be other various movable bodies. The emergency evacuation device 100 can be used as a device for planning a behavior of a mobile object such as an in-building movable robot for inspecting the inside of a building, a line inspection robot, or a personal mobility, for example. In a case where the mobile object is other than an automobile, regarding detection information by the road information detection unit, a traveling possible area on a route for the mobile object to travel may be acquired as road information. As obstacle information acquired by the roadside unit, information from an obstacle information detection unit provided in a building, a line, or a range in which a personal mobility moves, for example, may be used.

Since each sensor of the obstacle information detection unit 12, each sensor of the occupant state detection unit 32, and each sensor of the mobile object state detection unit 42 are mounted to the mobile object, these units may be configured to be included in the mobile object control system 1000.

In the above embodiments, dimensions, shapes, relative arrangement relationships, implementation conditions, or the like of constituent components may have been described, but they are merely examples in all aspects and are not limited to those described in the disclosure. Such features can be applied alone or in various combinations to one or more of the embodiments of the disclosure.

It is therefore understood that numerous modifications and equivalents which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

Unless there is no contradiction, a constituent component described as “one” component provided in the above embodiments may be provided as “one or more” components.

Each constituent component in the above embodiments is a conceptual unit, and the technical scope disclosed in the disclosure includes a case where one constituent component is formed of a plurality of parts, a case where one constituent component corresponds to a part of a structural body, and a plurality of constituent components are provided to one structural body.

Each constituent component in the above embodiments may be a part having another structure or shape, as long as the same function is exerted.

Descriptions in the disclosure are referred to for all purposes regarding the technical features disclosed here, and none of these are considered to be conventional art.

Each constituent component described in the above embodiments may be implemented as software or firmware, or as hardware corresponding thereto. In both concepts, each constituent component is referred to as “unit”, “processing circuit”, etc.

Hereinafter, modes of the present disclosure are summarized as additional notes.

(Additional Note 1)

An emergency evacuation device which receives obstacle information around a mobile object acquired by an obstacle information acquisition unit, obstacle information around a roadside acquired by a roadside information acquisition unit, physiological state information of an occupant of the mobile object acquired by an occupant state information acquisition unit, and mobile object state information which is a control state of the mobile object acquired by a mobile object state information acquisition unit, the emergency evacuation device comprising:
an emergency stop requesting unit which outputs an emergency stop request when having detected abnormality for at least one of the obstacle information around the mobile object acquired by the obstacle information acquisition unit, the obstacle information around the roadside acquired by the roadside information acquisition unit, and the physiological state information of the occupant;
a movement permission determination unit which determines whether or not to permit movement of the mobile object, on the basis of the emergency stop request outputted from the emergency stop requesting unit;
a movement permission cancellation unit which determines whether or not to cancel the movement permission for the mobile object, on the basis of the mobile object state information and the movement permission outputted from the movement permission determination unit; and
a mobile object control unit which controls movement of the mobile object on the basis of the movement permission outputted from the movement permission determination unit and the movement permission cancellation outputted from the movement permission cancellation unit, wherein
in a case where the emergency stop request is outputted from the emergency stop requesting unit, the movement permission determination unit outputs the movement permission for the mobile object,
in a case where output from the movement permission determination unit is the movement permission and output from the movement permission cancellation unit is not the cancellation, the mobile object control unit performs control so as to move the mobile object, and
in a case where output from the movement permission determination unit is not the movement permission or output from the movement permission cancellation unit is the cancellation, the mobile object control unit performs control so as to stop the mobile object.

(Additional Note 2)

An emergency evacuation device which receives obstacle information around a mobile object acquired by an obstacle information acquisition unit, obstacle information around a roadside acquired by a roadside information acquisition unit, physiological state information of an occupant of the mobile object acquired by an occupant state information acquisition unit, mobile object state information which is a control state of the mobile object acquired by a mobile object state information acquisition unit, road information around the mobile object acquired by a road information acquisition unit, and position information of the mobile object acquired by an own-position acquisition unit, the emergency evacuation device comprising:
an emergency stop requesting unit which outputs an emergency stop request when having detected abnormality for at least one of the obstacle information around the mobile object acquired by the obstacle information acquisition unit, the obstacle information around the roadside acquired by the roadside information acquisition unit, and the physiological state information of the occupant;
a movement permission determination unit which determines whether or not to permit movement of the mobile object, on the basis of the emergency stop request outputted from the emergency stop requesting unit, the road information, and the position information of the mobile object;
a movement permission cancellation unit which determines whether or not to cancel the movement permission for the mobile object, on the basis of the mobile object state information and the movement permission outputted from the movement permission determination unit; and
a mobile object control unit which controls movement of the mobile object on the basis of the movement permission outputted from the movement permission determination unit and the movement permission cancellation outputted from the movement permission cancellation unit, wherein
in a case where the emergency stop request is outputted from the emergency stop requesting unit, if the mobile object will stop in an area where advancement of another traffic participant is obstructed at a time of stoppage of the mobile object, the movement permission determination unit outputs the movement permission for the mobile object,
in a case where output from the movement permission determination unit is the movement permission and output from the movement permission cancellation unit is not the cancellation, the mobile object control unit performs control so as to move the mobile object to outside of the area, and
in a case where output from the movement permission determination unit is not the movement permission or output from the movement permission cancellation unit is the cancellation, the mobile object control unit performs control so as to stop the mobile object.

(Additional Note 3)

The emergency evacuation device according to additional note 1 or 2, wherein
the mobile object state information acquisition unit acquires at least one of a steering amount, a speed, and a movement distance of the mobile object, as the control state, and
in a case where at least one of a state in which the steering amount is greater than a predetermined value, a state in which the speed is greater than a predetermined value, and a state in which the movement distance after movement of the mobile object is greater than a predetermined value, is satisfied, the movement permission cancellation unit cancels the movement permission for the mobile object.

(Additional Note 4)

The emergency evacuation device according to any one of additional notes 1 to 3, wherein
the mobile object control unit includes at least one of a traveling mode control unit for setting a traveling mode of the mobile object, and a braking unit for releasing braking means of the mobile object,
in a case where the mobile object control unit includes the traveling mode control unit,
   the traveling mode control unit sets the traveling mode to a limited manual traveling mode in a case where output from the movement permission determination unit is the movement permission and output from the movement permission cancellation unit is not the cancellation, and
   the traveling mode control unit sets the traveling mode to an emergency stop mode in a case where output from the movement permission determination unit is not the movement permission or output from the movement permission cancellation unit is the cancellation, and
in a case where the mobile object control unit includes the braking unit,
   the braking unit releases the braking means in a case where output from the movement permission determination unit is the movement permission and output from the movement permission cancellation unit is not the cancellation, and
   the braking unit activates the braking means in a case where output from the movement permission determination unit is not the movement permission or output from the movement permission cancellation unit is the cancellation.

(Additional Note 5)

The emergency evacuation device according to any one of additional notes 1 to 3, wherein
the mobile object control unit includes at least one of a traveling mode control unit for setting a traveling mode of the mobile object, and a braking unit for releasing braking means of the mobile object,
in a case where the mobile object control unit includes the traveling mode control unit,
   the traveling mode control unit sets the traveling mode to a limited manual traveling mode in a case where output from the movement permission determination unit is the movement permission and output from the movement permission cancellation unit is not the cancellation, and
   the traveling mode control unit sets the traveling mode to an emergency stop mode in a case where output from the movement permission determination unit is not the movement permission or output from the movement permission cancellation unit is the cancellation, and
in a case where the mobile object control unit includes the braking unit,
   the braking unit activates the braking means in a case where output from the movement permission determination unit is the movement permission and output from the movement permission cancellation unit is not the cancellation, and the braking unit releases the braking means when the braking means is manually operated to be released.

(Additional Note 6)

The emergency evacuation device according to additional note 5, wherein
the mobile object control unit includes the braking unit, and
after the braking means is manually operated to be released, if the braking means is manually operated to be activated at least once, the braking unit continues activation of the braking means.

(Additional Note 7)

The emergency evacuation device according to any one of additional notes 1 to 6, wherein
the mobile object control unit includes at least one of a steering unit for controlling steering means, and a mobile object speed control unit for controlling mobile object speed control means,
in a case where the mobile object control unit includes the steering unit,
   the steering unit limits a steering angle or a steering speed of the steering means to less than a predetermined value, in a case where output from the movement permission determination unit is the movement permission and output from the movement permission cancellation unit is not the cancellation, and
in a case where the mobile object control unit includes the mobile object speed control unit,
   the mobile object speed control unit limits an upper limit speed of the mobile object speed control means to less than a predetermined value, in a case where output from the movement permission determination unit is the movement permission and output from the movement permission cancellation unit is not the cancellation.

(Additional Note 8)

The emergency evacuation device according to additional note 7, wherein
in a case where the mobile object control unit includes the steering unit,
   the steering unit limits the steering angle or the steering speed to be reduced on the basis of a movement distance after movement of the mobile object, and
in a case where the mobile object control unit includes the mobile object speed control unit,
   the mobile object speed control unit limits the upper limit speed to be reduced on the basis of the movement distance after movement of the mobile object.

(Additional Note 9)

The emergency evacuation device according to additional note 2, further comprising the obstacle information acquisition unit, the roadside information acquisition unit, the occupant state information acquisition unit, the mobile object state information acquisition unit, the road information acquisition unit, and the own-position acquisition unit.

(Additional Note 10)

A mobile object control system which controls a mobile object, using the emergency evacuation device according to additional note 2 and an information acquisition unit including the obstacle information acquisition unit, the roadside information acquisition unit, the occupant state information acquisition unit, the mobile object state information acquisition unit, the road information acquisition unit, and the own-position acquisition unit.

(Additional Note 11)

An emergency evacuation method executed using an emergency evacuation device, the method comprising:
a step of acquiring obstacle information around a mobile object;
a step of acquiring obstacle information around a roadside;
a step of acquiring a physiological state of an occupant of the mobile object;
a step of acquiring a control state of the mobile object;
a step of acquiring road information around the mobile object;
a step of acquiring position information of the mobile object;
a step of outputting an emergency stop request when abnormality is detected for at least one of the obstacle information around the mobile object, the obstacle information around the roadside, and the physiological state information of the occupant that have been acquired;
a movement permission determination step of determining whether or not to permit movement of the mobile object, on the basis of the outputted emergency stop request, the road information, and the position information of the mobile object;
a movement permission cancellation step of determining whether or not to cancel the movement permission for the mobile object, on the basis of the control state of the mobile object and a content of the determination in the movement permission determination step; and
a step of controlling movement of the mobile object on the basis of the content of the determination in the movement permission determination step and a content of the determination in the movement permission cancellation step, wherein
in the movement permission determination step,
   in a case where the emergency stop request is outputted, if the mobile object will stop in an area where advancement of another traffic participant is obstructed at a time of stoppage of the mobile object, the movement permission for the mobile object is outputted, and
in the step of controlling movement of the mobile object,
   in a case where the determination in the movement permission determination step is the movement permission and the determination in the movement permission cancellation step is not the cancellation, the mobile object is controlled so as to move to outside of the area, and
   in a case where the determination in the movement permission determination step is not the movement permission or the determination in the movement permission cancellation step is the cancellation, the mobile object is controlled so as to stop.

(Additional Note 12)

The emergency evacuation method according to additional note 11, wherein
in the step of acquiring the control state of the mobile object, at least one of a steering amount, a speed, and a movement distance of the mobile object is acquired as the control state of the mobile object, and
in the movement permission cancellation step,
   in a case where at least one of a state in which the steering amount is greater than a predetermined value, a state in which the speed is greater than a predetermined value, and a state in which the movement distance after movement of the mobile object is greater than a predetermined value, is satisfied, the movement permission for the mobile object is determined to be cancelled.

### DESCRIPTION OF THE REFERENCE CHARACTERS

10 obstacle information acquisition unit
12, 12a, 12b, 12c, 12d, 12e, 12f, 12g obstacle information detection unit
20 roadside information acquisition unit
30 occupant state information acquisition unit
32 occupant state detection unit
40 mobile object state information acquisition unit
42 mobile object state detection unit
50 road information acquisition unit
60 own-position acquisition unit
62 own-position detection unit
100 emergency evacuation device
120 emergency stop requesting unit
140 movement permission determination unit
160 movement permission cancellation unit
180 mobile object control unit
181 traveling mode control unit
182 braking unit
183 steering unit
184 mobile object speed control unit
200 information acquisition unit
1000 mobile object control system
1001 processing circuit
1002 storage device
1003 input/output circuit
1004 communication circuit
2000 drive-system equipment
OV own vehicle
RU roadside unit
RUA area
CNF area
SN1, SN2, SN3, SN4, SN5, SN6, SN7 detection range
SL1, SL2, SL3, SL4 stop line
SP stop position
STR straight route

What is claimed is:

1. An emergency evacuation device to receive obstacle information around a mobile object acquired by an obstacle information acquirer, obstacle information around a roadside acquired by a roadside information acquirer, physiological state information of an occupant of the mobile object acquired by an occupant state information acquirer, and mobile object state information which is a control state of the mobile object acquired by a mobile object state information acquirer, the emergency evacuation device comprising:
an emergency stop requester to output an emergency stop request when having detected abnormality for at least one of the obstacle information around the mobile object acquired by the obstacle information acquirer, the obstacle information around the roadside acquired by the roadside information acquirer, and the physiological state information of the occupant;
a movement permission determiner to determine whether or not to permit movement of the mobile object, on the basis of the emergency stop request outputted from the emergency stop requester;
a movement permission canceller to determine whether or not to cancel the movement permission for the mobile object, on the basis of the mobile object state information and the movement permission outputted from the movement permission determiner; and
a mobile object controller to control movement of the mobile object on the basis of the movement permission outputted from the movement permission determiner and the movement permission cancellation outputted from the movement permission canceller, wherein
in a case where the emergency stop request is outputted from the emergency stop requester, the movement permission determiner outputs the movement permission for the mobile object,
in a case where output from the movement permission determiner is the movement permission and output from the movement permission canceller is not the cancellation, the mobile object controller performs control so as to move the mobile object, and
in a case where output from the movement permission determiner is not the movement permission or output from the movement permission canceller is the cancellation, the mobile object controller performs control so as to stop the mobile object.

2. An emergency evacuation device which receives obstacle information around a mobile object acquired by an obstacle information acquirer, obstacle information around a roadside acquired by a roadside information acquirer, physiological state information of an occupant of the mobile object acquired by an occupant state information acquirer, mobile object state information which is a control state of the mobile object acquired by a mobile object state information acquirer, road information around the mobile object acquired by a road information acquirer, and position information of the mobile object acquired by an own-position acquirer, the emergency evacuation device comprising:
an emergency stop requester which outputs an emergency stop request when having detected abnormality for at least one of the obstacle information around the mobile object acquired by the obstacle information acquirer, the obstacle information around the roadside acquired by the roadside information acquirer, and the physiological state information of the occupant;
a movement permission determiner which determines whether or not to permit movement of the mobile object, on the basis of the emergency stop request outputted from the emergency stop requester, the road information, and the position information of the mobile object;
a movement permission canceller to determine whether or not to cancel the movement permission for the mobile object, on the basis of the mobile object state information and the movement permission outputted from the movement permission determiner; and
a mobile object controller to control movement of the mobile object on the basis of the movement permission outputted from the movement permission determiner and the movement permission cancellation outputted from the movement permission canceller, wherein
in a case where the emergency stop request is outputted from the emergency stop requester, if the mobile object will stop in an area where advancement of another traffic participant is obstructed at a time of stoppage of the mobile object, the movement permission determiner outputs the movement permission for the mobile object,
in a case where output from the movement permission determiner is the movement permission and output from the movement permission canceller is not the cancellation, the mobile object controller performs control so as to move the mobile object to outside of the area, and
in a case where output from the movement permission determiner is not the movement permission or output from the movement permission canceller is the cancellation, the mobile object controller performs control so as to stop the mobile object.

3. The emergency evacuation device according to claim 1, wherein
the mobile object state information acquirer acquires at least one of a steering amount, a speed, and a movement distance of the mobile object, as the control state, and
in a case where at least one of a state in which the steering amount is greater than a predetermined value, a state in which the speed is greater than a predetermined value, and a state in which the movement distance after movement of the mobile object is greater than a predetermined value, is satisfied, the movement permission canceller cancels the movement permission for the mobile object.

4. The emergency evacuation device according to claim 1, wherein
the mobile object controller includes at least one of a traveling mode controller to set a traveling mode of the mobile object, and a braking device to release a brake of the mobile object,
in a case where the mobile object controller includes the traveling mode controller,
the traveling mode controller sets the traveling mode to a limited manual traveling mode in a case where output from the movement permission determiner is the movement permission and output from the movement permission canceller is not the cancellation, and
the traveling mode controller sets the traveling mode to an emergency stop mode in a case where output from the movement permission determiner is not the movement permission or output from the movement permission canceller is the cancellation, and
in a case where the mobile object controller includes the braking device,
the braking device releases the brake in a case where output from the movement permission determiner is the movement permission and output from the movement permission canceller is not the cancellation, and
the braking device activates the brake in a case where output from the movement permission determiner is not the movement permission or output from the movement permission canceller is the cancellation.

5. The emergency evacuation device according to claim 1, wherein
the mobile object controller includes at least one of a traveling mode controller to set a traveling mode of the mobile object, and a braking device to release a brake of the mobile object,
in a case where the mobile object controller includes the traveling mode controller,
the traveling mode controller sets the traveling mode to a limited manual traveling mode in a case where output from the movement permission determiner is the movement permission and output from the movement permission canceller is not the cancellation, and
the traveling mode control unit sets the traveling mode to an emergency stop mode in a case where output from the movement permission determiner is not the movement permission or output from the movement permission canceller is the cancellation, and
in a case where the mobile object controller includes the braking device,
the braking device activates the brake in a case where output from the movement permission determiner is the movement permission and output from the movement permission canceller is not the cancellation, and the braking device releases the brake when the brake is manually operated to be released.

6. The emergency evacuation device according to claim 5, wherein
the mobile object controller includes the braking device, and
after the brake is manually operated to be released, if the brake is manually operated to be activated at least once, the braking device continues activation of the brake.

7. The emergency evacuation device according to claim 1, wherein
the mobile object controller includes at least one of a steering controller to control a steering, and a mobile object speed controller to control a mobile object speed control device,
in a case where the mobile object controller includes the steering,
the steering controller limits a steering angle or a steering speed of the steering to less than a predetermined value, in a case where output from the movement permission determiner is the movement permission and output from the movement permission canceller is not the cancellation, and
in a case where the mobile object controller includes the mobile object speed controller,
the mobile object speed controller limits an upper limit speed of the mobile object speed control device to less than a predetermined value, in a case where output from the movement permission determiner is the movement permission and output from the movement permission canceller is not the cancellation.

8. The emergency evacuation device according to claim 7, wherein
in a case where the mobile object controller includes the steering controller,
the steering controller limits the steering angle or the steering speed to be reduced on the basis of a movement distance after movement of the mobile object, and
in a case where the mobile object controller includes the mobile object speed controller,
the mobile object speed controller limits the upper limit speed to be reduced on the basis of the movement distance after movement of the mobile object.

9. The emergency evacuation device according to claim 2, further comprising the obstacle information acquirer, the roadside information acquirer, the occupant state information acquirer, the mobile object state information acquirer, the road information acquirer, and the own-position acquirer.

10. A mobile object control system which controls a mobile object, using the emergency evacuation device according to claim 2 and an information acquirer including the obstacle information acquirer, the roadside information acquirer, the occupant state information acquirer, the mobile object state information acquirer, the road information acquirer, and the own-position acquirer.

11. An emergency evacuation method executed using an emergency evacuation device, the method comprising:
a step of acquiring obstacle information around a mobile object;
a step of acquiring obstacle information around a roadside;
a step of acquiring a physiological state of an occupant of the mobile object;
a step of acquiring a control state of the mobile object;
a step of acquiring road information around the mobile object;
a step of acquiring position information of the mobile object;
a step of outputting an emergency stop request when abnormality is detected for at least one of the obstacle information around the mobile object, the obstacle information around the roadside, and the physiological state information of the occupant that have been acquired;
a movement permission determination step of determining whether or not to permit movement of the mobile object, on the basis of the outputted emergency stop request, the road information, and the position information of the mobile object;
a movement permission cancellation step of determining whether or not to cancel the movement permission for the mobile object, on the basis of the control state of the mobile object and a content of the determination in the movement permission determination step; and
a step of controlling movement of the mobile object on the basis of the content of the determination in the movement permission determination step and a content of the determination in the movement permission cancellation step, wherein
in the movement permission determination step,
in a case where the emergency stop request is outputted, if the mobile object will stop in an area where advancement of another traffic participant is obstructed at a time of stoppage of the mobile object, the movement permission for the mobile object is outputted, and
in the step of controlling movement of the mobile object,
in a case where the determination in the movement permission determination step is the movement permission and the determination in the movement permission cancellation step is not the cancellation, the mobile object is controlled so as to move to outside of the area, and
in a case where the determination in the movement permission determination step is not the movement permission or the determination in the movement permission cancellation step is the cancellation, the mobile object is controlled so as to stop.

12. The emergency evacuation method according to claim 11, wherein
in the step of acquiring the control state of the mobile object, at least one of a steering amount, a speed, and a movement distance of the mobile object is acquired as the control state of the mobile object, and
in the movement permission cancellation step,
in a case where at least one of a state in which the steering amount is greater than a predetermined value, a state in which the speed is greater than a predetermined value, and a state in which the movement distance after movement of the mobile object is greater than a predetermined value, is satisfied, the movement permission for the mobile object is determined to be cancelled.

13. The emergency evacuation device according to claim 2, wherein
the mobile object state information acquirer acquires at least one of a steering amount, a speed, and a movement distance of the mobile object, as the control state, and
in a case where at least one of a state in which the steering amount is greater than a predetermined value, a state in which the speed is greater than a predetermined value, and a state in which the movement distance after movement of the mobile object is greater than a predetermined value, is satisfied, the movement permission canceller cancels the movement permission for the mobile object.

14. The emergency evacuation device according to claim 2, wherein
the mobile object controller includes at least one of a traveling mode controller to set a traveling mode of the mobile object, and a braking device to release a brake of the mobile object,
in a case where the mobile object controller includes the traveling mode controller,
the traveling mode controller sets the traveling mode to a limited manual traveling mode in a case where output from the movement permission determiner is the movement permission and output from the movement permission canceller is not the cancellation, and
the traveling mode controller sets the traveling mode to an emergency stop mode in a case where output from the movement permission determiner is not the movement permission or output from the movement permission canceller is the cancellation, and
in a case where the mobile object controller includes the braking device,
the braking device releases the brake in a case where output from the movement permission determiner is the movement permission and output from the movement permission canceller is not the cancellation, and
the braking device activates the brake in a case where output from the movement permission determiner is not the movement permission or output from the movement permission canceller is the cancellation.

15. The emergency evacuation device according to claim 2, wherein
the mobile object controller includes at least one of a traveling mode controller to set a traveling mode of the mobile object, and a braking device to release a brake of the mobile object,
in a case where the mobile object controller includes the traveling mode controller,
the traveling mode controller sets the traveling mode to a limited manual traveling mode in a case where output from the movement permission determiner is the movement permission and output from the movement permission canceller is not the cancellation, and
the traveling mode controller sets the traveling mode to an emergency stop mode in a case where output from the movement permission determiner is not the movement permission or output from the movement permission canceller is the cancellation, and
in a case where the mobile object controller includes the braking device,
the braking device activates the brake in a case where output from the movement permission determiner is the movement permission and output from the movement permission canceller is not the cancellation, and the braking device releases the brake when the brake is manually operated to be released.

16. The emergency evacuation device according to claim 3, wherein
the mobile object controller includes at least one of a traveling mode controller to set a traveling mode of the mobile object, and a braking device to release a brake of the mobile object,
in a case where the mobile object controller includes the traveling mode controller,
the traveling mode controller sets the traveling mode to a limited manual traveling mode in a case where output from the movement permission determiner is the movement permission and output from the movement permission canceller is not the cancellation, and
the traveling mode controller sets the traveling mode to an emergency stop mode in a case where output from the movement permission determiner is not the movement permission or output from the movement permission canceller is the cancellation, and
in a case where the mobile object controller includes the braking device,
the braking device activates the brake in a case where output from the movement permission determiner is the movement permission and output from the movement permission canceller is not the cancellation, and the braking device releases the brake when the brake is manually operated to be released.

17. The emergency evacuation device according to claim 15, wherein
the mobile object controller includes the braking device, and
after the brake is manually operated to be released, if the brake is manually operated to be activated at least once, the braking device continues activation of the brake.

18. The emergency evacuation device according to claim 16, wherein
the mobile object controller includes the braking device, and
after the brake is manually operated to be released, if the brake is manually operated to be activated at least once, the braking device continues activation of the brake.

19. The emergency evacuation device according to claim 2, wherein
the mobile object controller includes at least one of a steering controller to control a steering, and a mobile object speed controller to control a mobile object speed control device,
in a case where the mobile object controller includes the steering,
the steering controller limits a steering angle or a steering speed of the steering to less than a predetermined value, in a case where output from the movement permission determiner is the movement permission and output from the movement permission canceller is not the cancellation, and
in a case where the mobile object controller includes the mobile object speed controller,
the mobile object speed controller limits an upper limit speed of the mobile object speed control device to less than a predetermined value, in a case where output from the movement permission determiner is the movement permission and output from the movement permission canceller is not the cancellation.
